(19) United States
(12) Patent Application Publication
(10) Pub. No.: US 2023/0142166 A1
(43) Pub. Date: May 11, 2023

(54) ETHYLENE POLYMER BLEND COMPOSITION FOR ADDITIVE-MANUFACTURE FEEDSTOCK

(71) Applicant: BRASKEM AMERICA, INC., Philadelphia, PA (US)

(72) Inventors: Michelle K. Sing, Pittsburgh, PA (US); Juliana Breda Soares, Pittsburgh, PA (US); Jacob Fallon, Pittsburgh, PA (US); Collin Azinger, Pittsburgh, PA (US)

(21) Appl. No.: 17/983,593

(22) Filed: Nov. 9, 2022

Related U.S. Application Data
(60) Provisional application No. 63/277,750, filed on Nov. 10, 2021.

(51) Int. Cl. C08L 23/06

(52) U.S. Cl. CPC C08L 23/06; C08L 2207/062; C08L 2207/04; C08L 2205/03

(57) ABSTRACT

The invention relates to an additive-manufacture feedstock, comprising an ethylene polymer blend composition having an ethylene polymer having a melt flow index of from 0.1 to 150 g/10 min (190° C./2.16 kg), measured according to ASTM D 1238, and at least one of the following components blended in the ethylene polymer: a polyolefin elastomer, an ethylene-vinyl ester polymer, a fiber, a nucleator or clarifier, or a polypropylene polymer. The additive-manufacture feedstock, when in the form of a printed article, exhibits an improved printability characterized by an improved warpage-resistance rating. The invention also relates to methods of making the additive-manufacture feedstock and methods of 3D printing or additive manufacturing using the additive-manufacture feedstock in various forms.

### PRIORITY CLAIM

This application claims the benefit of priority to U.S. Provisional Patent Application No. 63/277,750, filed on Nov. 10, 2021, which is herein incorporated by reference in its entirety.

### FIELD OF THE INVENTION

This invention generally relates to an additive-manufacture feedstock comprising an ethylene polymer blend composition in the field of 3D printing.

### BACKGROUND OF THE INVENTION

3D printing of polymer materials employing fused filament fabrication technology (FFF) (also known as fused deposition modelling, FDM) has gained wide popularity due to its capability of fabricating intricate geometries. However, these material-extrusion-based 3D printing technologies are sensitive to part warping that occurs during the 3D printing process. Not only does warping result in the printed part deforming relative to the initial design, but warping can also cause catastrophic failures in the printing process itself.

Originally, a majority of polymer materials for 3D printing were amorphous materials. More recently, polyolefins such as polyethylene and polypropylene have become of an interest to the 3D printing industry for their mechanical properties, chemical resistance, and abundance of supply. In particular, polyethylene such as HDPE is one of the most commonly used thermoplastics for producing a wide variety of objects, such as pipes, rigid bottles, and buckets.

Postconsumer HDPE plastics can be recycled as the feedstock for 3D printers. However, 3D printing of HDPE polymer is quite challenging because the polymer is often prone to warping. HDPE is a semicrystalline polymer that rapidly crystallizes on cooling from the melt state and subsequently shrinks in volume. As the printing process continues in a layer-by-layer fashion, internal stresses within the printed part are generated. These stresses result in the deformation of the highly stressed layers, which can cause not only poor dimensional accuracy but also failures of building, e.g., between the deposited layers and the printer bed and/or between subsequent layers of a printed part. Warpage is often highest at sharp corners where stresses are concentrated and difficult to resist. Further, the low surface energy and low polarity of the HDPE polymer can also result in poor adhesion to the 3D printer bed, which can cause an unsuccessful printing process. This poor adhesion to the printer bed can also exacerbate issues with part warping.

There thus remains a need in the art to develop a polyethylene-based additive-manufacture feedstock that provides an improved processability and printability for 3D printing, such as improved warpage resistance to the printed articles.

### SUMMARY OF THE INVENTION

In one aspect, provided herein is an additive-manufacture feedstock comprising an ethylene polymer blend composition having an ethylene polymer having a melt flow index of from 0.1 to 150 g/10 min (190° C./2.16 kg), measured according to ASTM D 1238. The ethylene polymer blend composition also comprises at least one component blended in the ethylene polymer selected from the group consisting of: a polyolefin elastomer, an ethylene-vinyl ester polymer, a fiber, a nucleator or clarifier, a polypropylene polymer, and combinations thereof. The ethylene polymer blend composition has an ethylene content of at least 50 wt %. The additive-manufacture feedstock, when in the form of a printed article, exhibits an improved printability characterized by an improved warpage-resistance rating of at least 20%, as compared to a printed article made from the same ethylene polymer without the blended component in the additive-manufacture feedstock.

The warpage resistance rating of the printed article made from the ethylene polymer blend composition may be measured according to the following equation:

$$warpage resistance rating \% = 100 \times \frac{{\sum }_{i = 1}^{N} {WS}_{i}}{N} \%$$

In this equation:
Σᵢ₌₁^{N} WSᵢ sums the values of WSi, starting at WS₁ and ending with WS_{N},
N is the total number of printed articles measured for warpage resistance rating evaluation,
i is a i^{th} printed article measured,
WSi=[Max (X₁,X₂,X₃,X₄)ᵢ−Min (Y₁,Y₂,Y₃,Y₄)ᵢ]/Max (X₁,X₂,X₃,X₄)ᵢ for a i^{th} printed article measured,
X₁, X₂, X₃, and X₄, respectively, represent a height of a first central edge, a height of a second central edge, a height of a third central edge, and a height of a fourth central edge, of the i^{th} printed article measured,
Y₁, Y₂, Y₃, and Y₄, respectively, represent a height of a first corner edge, a height of a second corner edge, a height of a third corner edge, and a height of a fourth corner edge, of the i^{th} printed article measured,
Max (X₁,X₂,X₃,X₄)ᵢ represents the maximum value of X₁, X₂, X₃, and X₄, for the i^{th} printed article measured, and
Min (Y₁,Y₂,Y₃,Y₄)ᵢ represents the minimum value of Y₁, Y₂, Y₃, and Y₄, for the i^{th} printed article measured.
   Each printed article measured for warpage resistance rating evaluation is a 60 mm×60 mm×h mm box, wherein h is from 30 mm to 60 mm; and each side of the box has a thickness of 1 mm.

In another aspect, provided herein is a filament formed from the additive-manufacture feedstock as described from the above aspects of the invention.

In another aspect, provided herein is a powder formed from the additive-manufacture feedstock as described from the above aspects of the invention.

Another aspect of the invention relates to a distribution (or a suspension) of pellets, each pellet formed from the additive-manufacture feedstock as described from the above aspects of the invention.

Another aspect of the invention relates to a method of making an additive-manufacture feedstock. The method comprises: blending or compounding an ethylene polymer having a melt flow index of from 0.1 to 150 g/10 min (190° C./2.16 kg), measured according to ASTM D 1238, with at least one component selected from the group consisting of: a polyolefin elastomer, an ethylene-vinyl ester polymer, a fiber, a nucleator or clarifier, a polypropylene polymer, and combinations thereof, to form the ethylene polymer blend composition having an ethylene content of at least 50 wt %. The additive-manufacture feedstock, when in the form of a printed article, exhibits an improved printability characterized by an improved warpage-resistance rating of at least 20%, as compared to a printed article made from the same ethylene polymer without the blended component in the additive-manufacture feedstock. The warpage resistance rating of the printed article may be measured according to the equation as described from the above aspects of the invention.

Another aspect of the invention relates to a method of three-dimensional printing or additive manufacturing. The method comprises: (1) supplying the additive-manufacture feedstock as described from the above aspects of the invention to a printing apparatus and forming a hot-melt of the additive-manufacture feedstock; (2) depositing the hot-melt of the additive-manufacture feedstock from the printing apparatus on a substrate to form a first deposited printing layer; (3) repeating steps (1) and (2) to deposit a second printing layer on the first printing layer; and (4) optionally depositing at least one further printing layer on said second printing layer.

Another aspect of the invention relates to a method of three-dimensional printing or additive manufacturing. The method comprises: (1) depositing a layer of the additive-manufacture feedstock as described from the above aspects of the invention to a printing apparatus; (2) irradiating the additive-manufacture feedstock at a temperature range that sinters the additive-manufacture feedstock and causes at least a portion of the additive-manufacture feedstock to fuse and form a first printing layer; (3) repeating steps (1) and (2) to form a second printing layer on the first printing layer; and (4) optionally forming at least one further printing layer on said second printing layer.

Another aspect of the invention relates to a method of three-dimensional printing or additive manufacturing. The method comprises coalescing the additive-manufacture feedstock as described from the above aspects of the invention.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### BRIEF DESCRIPTION OF THE DRAWINGS

FIGS. 1A-ID illustrate the method of measuring the warpage resistance rating. FIG. 1A shows the print orientation using 3D printing. FIG. 1B shows a printed open-ended, thin-walled box with the illustrations of the expected height of one edge from the model as well as the measured height of the printed box for the same edge, for warpage resistance rating evaluation. FIG. 1C illustrates an exemplary box projecting onto the X-Y plane and identifying the locations for X₁, X₂, X₃, and X₄, and Y₁, Y₂, Y₃, and Y₄, for warpage resistance rating equation. FIG. 1D provides another view and illustration for a hypothetical box for which the warpage resistance is determined, with the left panel showing the view of projecting the box onto the X-Y plane, and the right panel showing the view of the expected height from the center edge and the measured height from the corner edge.

### DETAILED DESCRIPTION OF THE INVENTION

The disclosure provides an additive-manufacture feedstock comprising an ethylene polymer blend composition that contains an ethylene polymer component and one or more other components (such as a polyolefin elastomer, an ethylene-vinyl ester polymer, a fiber, a nucleator or clarifier, and/or a polypropylene polymer) to produce a feedstock material which has an improved processability and printability for the polyethylene-based additive-manufacture feedstock in material-extrusion-based 3D printing technology, such as FFF and FPF. The resulting blended feedstock material results in an improved ability to print parts in material extrusion additive manufacturing by reducing the total crystallinity of the polyethylene, increasing the ability to adhere to existing substrates (such as polypropylene), and/or providing additional dimensional stability.

### Components for Additive-Manufacture Feedstock

One aspect of the invention relates to an additive-manufacture feedstock, comprising an ethylene polymer blend composition having an ethylene polymer having a melt flow index of from 0.1 to 150 g/10 min (190° C./2.16 kg), measured according to ASTM D 1238. The ethylene polymer blend composition also comprises at least one component blended in the ethylene polymer selected from the group consisting of: a polyolefin elastomer, an ethylene-vinyl ester polymer, a fiber, a nucleator or clarifier, a polypropylene polymer, and combinations thereof. The ethylene polymer blend composition has an ethylene content of at least 50 wt %.

In an embodiment, the additive-manufacture feedstock of the present invention comprises an ethylene polymer blend composition which comprises a polymeric fraction that consists of the ethylene polymer and at least one of the following components: a polyolefin elastomer, an ethylene-vinyl ester polymer, and a polypropylene polymer. The polymeric fraction has an ethylene content of at least 50 wt %.

The additive-manufacture feedstock, when in the form of a printed article, exhibits an improved printability characterized by an improved warpage-resistance rating of at least 20%, as compared to a printed article made from the same ethylene polymer without the blended component in the additive-manufacture feedstock.

The warpage resistance rating of the printed article made from the ethylene polymer blend composition may be measured according to the following equation:

$$warpage resistance rating \% = 100 \times \frac{{\sum }_{i = 1}^{N} {WS}_{i}}{N} \%$$

To determine the warpage resistance rating of the additive-manufacture feedstock, a number of specimens (articles) are printed and measured after the specimens (articles) are printed. Each printed article measured for warpage resistance rating evaluation is a 60 mm×60 mm×h mm box, wherein h is from 30 mm to 60 mm; and each side of the box has a thickness of 1 mm.

In the above equation, Σᵢ₌₁^{N} WSᵢ sums the values of WSi, starting at WS₁ and ending with WS_{N}. N is the total number of printed articles measured for warpage resistance rating evaluation, and i is an i^{th} printed article measured. As an example, three specimens (articles) are printed and measured for the warpage resistance rating evaluation. Typically, N is at least 3 for the warpage evaluation results to be statistically significant.

The warpage resistance value for each specimen is calculated as WSi=[Max (X₁,X₂,X₃,X₄)ᵢ−Min (Y₁,Y₂,Y₃,Y₄)ᵢ]/Max (X₁,X₂,X₃,X₄)ᵢ for an i^{th} printed article measured. In this formula, X₁, X₂, X₃, and X₄, respectively, represent a height of a first central edge, a height of a second central edge, a height of a third central edge, and a height of a fourth central edge, of the i^{th} printed article measured. Y₁, Y₂, Y₃, and Y₄, respectively, represent a height of a first corner edge, a height of a second corner edge, a height of a third corner edge, and a height of a fourth corner edge, of the i^{th} printed article measured. Max (X₁,X₂,X₃,X₄)ᵢ represents the maximum value of X₁, X₂, X₃, and X₄, for the i^{th} printed article measured. Min (Y₁,Y₂,Y₃,Y₄)ᵢ represents the minimum value of Y₁, Y₂, Y₃, and Y₄, for the i^{th} printed article measured.

The warpage resistance rating (%) calculated from this equation provides an indication of how well the additive-manufacture feedstock material used to print articles resists the thermodynamic warping that may occur during 3D printing of the articles. The lower the warpage resistance rating, the lower the warpage, and the better performance of the additive-manufacture feedstock material. The method for measuring the warpage resistance rating is discussed in detail in Example 2 and Example 3.

Based on the above equation for evaluating warpage, the ethylene polymer blend composition in the additive-manufacture feedstock, when in the form of a printed article, exhibits a warpage resistance rating of no more than about 10%, no more than about 9%, no more than about 8%, no more than about 7%, no more than about 6%, no more than about 5%, no more than about 4%, no more than about 3%, no more than about 2.5%, no more than about 2%, no more than about 1.5%, no more than about 1%, no more than about 0.5%, or virtually free of warpage.

In addition, the ethylene polymer blend composition in the additive-manufacture feedstock, when in the form of a printed article, exhibits an improved warpage-resistance rating of at least about 20% as compared to a polymer composition having the same ethylene polymer component, but without the other blended components in the additive-manufacture feedstock. A warpage-resistance means the material's resistance to warpage, and the less warpage the better warpage resistance. The term “improved” warpage resistance rating according to the equation described here refers to a decreased warpage resistance rating. In some embodiments, the ethylene polymer blend composition in the additive-manufacture feedstock, when in the form of a printed article, exhibits an improved warpage-resistance rating of at least about 30%, at least about 40%, at least about 50%, at least about 60%, at least about 70%, at least about 80%, at least about 90%, or virtually about 100%, as compared to a polymer composition having the same ethylene polymer component, but without the other blended components in the additive-manufacture feedstock.

It is to be understood that the measurement conditions for warpage resistance rating evaluation, such as the number of printed article, and the shape, dimension, and thickness of the specimen printed (i.e., three 60 mm×60 mm×h mm boxes), are for the purpose of measuring and evaluating warpage resistance rating only, and are by no means limiting the usage, i.e., 3D printing, of the additive-manufacture feedstock. The additive-manufacture feedstock can be printed in any shape, any dimension, with any thickness, depending on the desired model.

The main component in the ethylene polymer blend composition is an ethylene polymer. The term “ethylene polymer,” as used herein, refers to a polymer that comprises a majority weight percent polymerized ethylene monomer (based on the total amount of polymerizable monomers), and optionally may comprise at least one or more polymerized comonomers. The ethylene polymer may be an ethylene copolymer comprising at least one olefinic comonomer. Suitable comonomers for polymerizing with ethylene to form the ethylene polymer include, but are not limited to, an olefin (e.g., an α-olefin) and a monomer having at least two double bonds.

Exemplary olefins are linear, branched, or cyclic olefins (e.g., α-olefins) having 3 to 20 carbon atoms, 3 to 16 carbon atoms, or 3 to 12 carbon atoms, including but not limited to propylene, 1-butene, 2-butene, 1-pentene, 3-methyl-1-butene, 1-hexene, 4-methyl-1-pentene, 3-methyl-1-pentene, 1-heptene, 4-methyl-1-hexene, 5-methyl-1-hexene, 4,6-dimethyl-1-heptene, 1-octene, 1-nonene, 1-decene, 1-undecene, 1-dodecene, 1-tetradecene, 1-hexadecene, 1-octadecene, 1-eicocene, vinylcyclohexane, styrene, tetracyclododecene, norbornene, 5-ethylidene-2-norbornene (ENB), and combinations thereof. In the context of the present invention, ethylene and styrene are considered α-olefins. In one embodiment, the ethylene polymer is an ethylene copolymer comprising at least one olefinic comonomer selected from the group consisting of propylene, 1-butene, 1-pentene, isobutene, 1-hexene, 1-octene, and combinations thereof.

Exemplary monomers having at least two double bonds are dienes or trienes comonomers, including but not limited to butadiene (e.g., 1,3-butadiene); pentadienes (e.g., 1,3-pentadiene; 1,4-pentadiene; 3-methyl-1,4-pentadiene; 3,3-dimethyl-1,4-pentadiene); hexadienes (e.g., 1,3-hexadiene; 1,4-hexadiene; 1,5-hexadiene; 4-methyl-1,4-hexadiene; 5-methyl-1,4-hexadiene; 3-methyl-1,5-hexadiene; 3,4-dimethyl-1,5-hexadiene); heptadienes (e.g., 1,3-heptadiene; 1,4-heptadiene; 1,5-heptadiene; 1,6-heptadiene; 6-methyl-1,5-heptadiene); octadienes (e.g., 1,3-octadiene; 1,4-octadiene; 1,5-octadiene; 1,6-octadiene; 1,7-octadiene; 7-methyl-1,6-octadiene; 3,7-dimethyl-1,6-octadiene; 5,7-dimethyl-1,6-octadiene); nonadienes (e.g., 1,8-nonadiene); decadienes (e.g., 1,9-decadiene); undecadienes (e.g., 1,10-undecadiene); dicyclopentadienes; octatrienes (e.g., 3,7,11-trimethyl-1,6,10 octatriene); and combinations thereof.

The ethylene polymer may be high-density polyethylene (HDPE), linear low-density polyethylene (LLDPE), low-density polyethylene (LDPE), or medium-density polyethylene (MDPE). In one embodiment, the ethylene polymer is high-density polyethylene (HDPE).

In some embodiments, the ethylene polymer component has a melt index (“MI”), or a melt flow rate (“MFR”), from about 0.1 g/10 min to about 150 g/10 min, from about 0.1 g/10 min to about 30.0 g/10 min, from about 0.1 g/10 min to about 10.0 g/10 min, or from about 0.1 g/10 min to about 5.0 g/10 min, measured at 190° C. with a 2.16 kg melt indexer weight, in accordance with ASTM D 1238.

Alternatively, the ethylene polymer component has a melt flow rate from about 0.1 g/10 min to about 150 g/10 min, from about 0.1 g/10 min to about 50.0 g/10 min, from about 0.1 g/10 min to about 30.0 g/10 min, from about 0.1 g/10 min to about 20.0 g/10 min, from about 0.1 g/10 min to about 10.0 g/10 min, or from about 1 g/10 min to about 10.0 g/10 min, measured at 230° C. with a 2.16 kg melt indexer weight, in accordance with ASTM D 1238.

In some embodiments, the ethylene polymer component has a density from about 0.85 g/cm³ to about 0.99 g/cm³, from about 0.90 g/cm³ to about 0.99 g/cm³, from about 0.90 g/cm³ to about 0.95 g/cm³, from about 0.95 g/cm³ to about 0.99 g/cm³, or from about 0.93 g/cm³ to about 0.97 g/cm³, measured in accordance with ASTM D792.

The additive-manufacture feedstock may comprise one or more polypropylene polymers. The term “propylene polymer,” as used herein, refers to a polymer that comprises a majority weight percent polymerized propylene monomer (based on the total amount of polymerizable monomers), and optionally may comprise at least one or more polymerized comonomers. The polypropylene-based copolymer can be made up of linear and/or branched polymer chains, optionally containing long-chain branches. The polypropylene polymers may be present in an amount of from about 0.1 wt % to about 65 wt % relative to 100 wt % of the ethylene polymer blend composition. For instance, the polypropylene polymers may be present in the additive-manufacture feedstock in an amount of from about 0.1 wt % to about 60 wt %, from about 0.1 wt % to about 50 wt %, from about 0.1 wt % to about 40 wt %, from about 0.1 wt % to about 30 wt %, from about 0.1 wt % to about 20 wt %, from about 1 wt % to about 20 wt %, from about 5 wt % to about 20 wt %, or from about 10 wt % to about 20 wt %, relative to 100 wt % of the ethylene polymer blend composition.

Suitable polypropylene polymers include propylene homopolymers, propylene copolymers, and propylene interpolymers. The polypropylene homopolymer can be isotactic, syndiotactic, or atactic polypropylene. The polypropylene polymer can be a random copolymer, a block copolymer, an alternating copolymer, a periodic copolymer, an impact copolymer, or a propylene-based terpolymer. Reactor copolymers of polypropylene may also be used.

In some embodiments, the polypropylene polymer comprises at least one member selected from the group consisting of a polypropylene homopolymer, a polypropylene block copolymer, a polypropylene random copolymer (e.g., a random copolymer of propylene/α-olefin (diene), such as a random copolymer of propylene and ethylene), and a heterophasic copolymer (e.g., a heterophasic copolymer comprising a propylene-based polymer as the matrix phase and an olefin-based elastomer as the disperse phase such as a heterophasic copolymer comprising a propylene-based polymer as the matrix phase and an ethylene-based elastomer as the disperse phase).

In some embodiments, the polypropylene polymer component has a melt flow rate from about 0.1 g/10 min to about 150 g/10 min, from 0.5 g/10 min to about 150 g/10 min, from about 1 g/10 min to about 100 g/10 min, from about 1 g/10 min to about 50 g/10 min, or from about 1 g/10 min to about 30 g/10 min. The melt flow rate for the propylene-based polymer is measured at 230° C. with a 2.16 kg melt indexer weight, in accordance with ASTM D 1238.

The additive-manufacture feedstock may comprise one or more polyolefin elastomers blended in the ethylene polymer blend composition. The polyolefin elastomers may be present in an amount of from about 0.1 wt % to about 60 wt %, relative to 100 wt % of the ethylene polymer blend composition. For instance, the polyolefin elastomers may be present in the additive-manufacture feedstock in an amount of from about 0.1 wt % to about 50 wt %, from about 0.1 wt % to about 40 wt %, from about 0.1 wt % to about 30 wt %, from about 0.1 wt % to about 20 wt %, from about 1 wt % to about 20 wt %, from about 5 wt % to about 20 wt %, or from about 10 wt % to about 20 wt %, relative to 100 wt % of the ethylene polymer blend composition.

Polyolefin elastomers can improve impact toughness and overall mechanical properties of the ethylene polymer blend composition. Suitable polyolefin elastomers include those copolymers of at least two olefinic comonomers, e.g., olefins described above relating to the comonomers for polymerizing with ethylene to form the ethylene polymer. For instance, the polyolefin elastomers may be a copolymer of at least two olefinic comonomers from a C₂-C₁₀ olefin (e.g., C₂-C₁₀ α-olefin).

In some embodiments, the polyolefin elastomer is a copolymer of at least two olefinic comonomers selected from the group consisting of ethylene, propylene, butene, hexene, and octene. In one embodiment, the polyolefin elastomer is an ethylene-based elastomer. For instance, the polyolefin elastomer may be a propylene ethylene copolymer having an ethylene content of up to about 99 wt %, up to about 95 wt %, up to about 90 wt %, up to about 85 wt %, up to about 80 wt %, from about 1 to 80 wt %, from about 5 to 80 wt %, from about 10 to 80 wt %, from about 15 to 80 wt %, or from about 30 to 70 wt %.

Additional exemplary polyolefin elastomers are ethylene-butene random copolymers (e.g., Tafmer DF), propylene-butene random copolymers (e.g., Tafmer XN), ethylene-octene rubber (e.g., ENGAGE 8200), styrene-butadiene copolymers (e.g., KRATON), ethylene-propylene rubber/elastomer (e.g., Vistamaxx), impact modifiers, and mixtures thereof.

The additive-manufacture feedstock may comprise one or more ethylene-vinyl ester polymers blended in the ethylene polymer blend composition. The ethylene-vinyl ester polymers may be present in an amount of from about 0.1 wt % to about 60 wt %, relative to 100 wt % of the ethylene polymer blend composition. For instance, the ethylene-vinyl ester polymers may be present in the additive-manufacture feedstock in an amount of from about 0.1 wt % to about 50 wt %, from about 0.1 wt % to about 40 wt %, from about 0.1 wt % to about 30 wt %, from about 0.1 wt % to about 20 wt %, from about 1 wt % to about 20 wt %, from about 5 wt % to about 20 wt %, or from about 10 wt % to about 20 wt %, relative to 100 wt % of the ethylene polymer blend composition.

The ethylene-vinyl ester polymer used may be any polymer that includes an ethylene comonomer and one or more vinyl ester comonomers. Suitable vinyl ester comonomers include aliphatic vinyl esters having 3 to 20 carbon atoms (e.g., 4 to 10 carbon atoms or 4 to 7 carbon atoms). Exemplary vinyl esters are vinyl acetate, vinyl formate, vinyl propionate, vinyl valerate, vinyl butyrate, vinyl isobutyrate, vinyl pivalate, vinyl caprate, vinyl laurate, vinyl stearate, and vinyl versatate. Aromatic vinyl esters such as vinyl benzonate can also be used as vinyl ester comonomers. These vinyl ester comonomers can be used alone or in combination of two or more different ones.

Common vinyl ester comonomers used are vinyl acetate or vinyl versatate (e.g., the vinyl ester of versatic acid, vinyl neononanoate, or vinyl neodecanoate). Typically, vinyl acetate is used from the perspective of good commercial availability and impurity-treating efficiency at the production. The vinyl esters of neononanoic acid (vinyl neononanoate) and neodecanoic acid (vinyl neodecanoate) are commercial products obtained from the reaction of acetylene with neononanoic acids and neodecanoic acids, respectively, which are commercially available as Versatic acid 9 and Versatic acid 10. In some embodiments, the ethylene-vinyl ester polymer used is an ethylene-vinyl acetate polymer or an ethylene-vinyl acetate-vinyl versatate terpolymer.

The vinyl ester content in the ethylene-vinyl ester polymer can range from about 1.0 wt % to about 50 wt %, relative to 100 wt % of the ethylene-vinyl ester polymer, with the remainder being the ethylene content. Typically, the vinyl ester content is in the range of from about 1.0 wt % to about 50 wt %, from about 1.0 wt % to about 40 wt %, from about 1.0 wt % to about 35 wt %, from about 1.0 wt % to about 30 wt %, from 5.0 wt % to about 30 wt %, from about 5.5 wt % to about 28 wt %, from about 8.0 wt % to about 28 wt %, from about 5.5 wt % to about 20 wt %, from about 8.0 wt % to about 19 wt %, or from about 19 wt % to about 28 wt %, relative to 100 wt % of the ethylene-vinyl ester polymer.

The ethylene-vinyl ester polymers used may have a melt flow rate of from about 0.1 g/10 min to about 150 g/10 min, from about 0.1 g/10 min to about 100 g/10 min, from about 0.1 g/10 min to about 50 g/10 min, from about 0.1 to about 40 g/10 min, from about 0.1 g/10 min to about 30 g/10 min, from about 0.1 g/10 min to about 24 g/10 min, from about 0.1 g/10 min to about 20 g/10 min, from about 1 g/10 min to about 24 g/10 min, from about 1 g/10 min to about 20 g/10 min, from about 2 g/10 min to about 24 g/10 min, from about 2 g/10 min to about 20 g/10 min, from about 1 g/10 min to about 10 g/10 min, from about 2 g/10 min to about 10 g/10 min, or from about 2 g/10 min to about 6 g/10 min. The melt flow rate for the ethylene-vinyl ester polymer is measured at 190° C. with a 2.16 kg melt indexer weight, in accordance with ASTM D 1238.

In some embodiments, the ethylene-vinyl ester polymer used has a melt flow rate of from 0.1 to 150 g/10 min (190° C./2.16 kg), measured according to ASTM D 1238, and a vinyl ester content of from about 1.0 wt % to about 30 wt %, relative to 100 wt % of the ethylene-vinyl ester polymer.

The additive-manufacture feedstock may comprise one or more fibers blended in the ethylene polymer blend composition. The fibers may be present in an amount of from about 0.1 wt % to about 40 wt %, relative to 100 wt % of the ethylene polymer blend composition. For instance, the fibers may be present in the additive-manufacture feedstock in an amount of from about 0.1 wt % to about 30 wt %, from about 0.1 wt % to about 20 wt %, from about 1 wt % to about 20 wt %, from about 1 wt % to about 15 wt %, from about 5 wt % to about 15 wt %, from about 5 to about 10 wt %, relative to 100 wt % of the ethylene polymer blend composition.

The fibers to be blended in the ethylene polymer blend composition can include any fiber types suitable for reinforcement of the ethylene polymer. Exemplary fiber materials are glass fibers, carbon fibers, metal fibers, ceramic fibers, natural fibers, organic fibers, or a combination thereof. In one embodiment, one or more fibers blended in the ethylene polymer blend composition are a carbon fiber, metal fiber, or a combination thereof.

The term “fiber” as referred herein is defined by an aspect ratio, calculated by dividing the fiber length by its diameter, of about 3-500. In one embodiment, the fiber to be blended in the additive-manufacture feedstock has an aspect ratio of at least 10. The fibers to be blended in the additive-manufacture feedstock typically have a length of about 10 to 10,000 m. When the lengths of the fibers are too short, the ability of reinforcement can be affected. On the other hand, when the lengths of the fibers are too long, the fibers can be difficult to process during extrusion for preparing the feedstock. In one embodiment, the fiber in the additive-manufacture feedstock has a length, prior to blending, of from about 100 to 600 m. In some embodiments, the fiber length can be changed upon formation of the additive-manufacture feedstock. Thus, a length of the fiber prior to blending can be different from the length of the fiber after formation of the additive-manufacture feedstock.

The additive-manufacture feedstock may comprise one or more clarifiers and/or nucleators blended in the ethylene polymer blend composition. The nucleators or clarifiers may be present in an amount of from about 0.0001 wt % to about 10 wt %, from about 0.0001 wt % to about 5 wt %, from about 0.0001 wt % to about 1 wt %, from about 0.0001 wt % to about 0.5 wt %, from about 0.0001 wt % to about 0.25 wt %, from about 0.0001 wt % to about 0.2 wt %, from about 0.0001 wt % to about 0.15 wt %, from about 0.0001 wt % to about 0.1 wt %, from about 0.001 wt % to about 10 wt %, from about 0.01 wt % to about 10 wt %, from about 0.01 wt % to about 5 wt %, from about 0.01 wt % to about 1 wt %, from about 0.01 wt % to about 0.5 wt %, from about 0.01 wt % to about 0.1 wt %, from about 0.02 wt % to about 0.5 wt %, from about 0.03 wt % to about 0.25 wt %, from about 0.04 wt % to about 0.25 wt %, from about 0.05 wt % to about 0.25 wt %, from about 0.05 wt % to about 0.2 wt %, or from about 0.05 wt % to about 0.15 wt %, relative to 100% of the ethylene polymer blend composition.

A nucleator or clarifier can provide nucleation, promote crystallization of the polymer, control the rate, size, degree, and isotropy of crystallization, and improve clarity to polymer compositions. Suitable nucleators/clarifiers include, but are not limited to, a dicarboxylate metal salt, a sorbitol derivative, a trisamide, a phosphate ester salt, and mixtures thereof.

Exemplary dicarboxylate metal salts include Hyperform® HPN-68L (bicyclo[2.2.1]heptane dicarboxylate salt), and Hyperform® HPN-20E (a dicarboxylate calcium metal salt), which are commercially available via Milliken & Company.

Exemplary sorbitol derivatives include Millad 3905 (1,2,3,4-dibenzylidene sorbitol), Millad 3940 (1,2,3,4-di-para-methylbenzylidene sorbitol), Millad 3988 (1,2,3,4-di-meta, para-methylbenzylidene sorbitol), and Millad NX8000 (1,2,3-trideoxy-4,5:5,7-bis-O-[(4-propylphenyl)methylene]-Nonitol), all of which are commercially available via Milliken & Company.

Exemplary trisamides include trisamide benzene compounds, such as Irgaclear® XT386 (N,N′,N″-benzene-1,3,5-triyltris(2,2-dimethylpropanamide)), and RiKaclear® PC1 (N,N′,N″-Tris (2-methylcyclohexyl)-1,2,3-propanetricarboxamide.

Exemplary phosphate ester salts include NA-11 (sodium 2,2′-methylene-bis-(4,6-di-tert-butylphenyl) phosphate), NA-21 (aluminum hydroxybis[2,4,8,10-tetrakis(1,1-dimethylethyl)-6-hydroxy-12H-dibenzo[d,g][1,3,2]dioxaphoshocin 6-oxidato]), NA-71, NA-806A, NA-27, and NA-902, all of which are commercially available via Amfine Chemical Corporation.

Additional suitable nucleators/clarifiers may be found in U.S. Patent Application Publication No. 2020/0079943, U.S. Patent Application Publication No. 2020/0277480, and U.S. Pat. No. 7,659,336, which are incorporated herein by reference in their entirety.

Overall, the ethylene polymer blend composition may have an ethylene content of at least about 50 wt %, at least about 55 wt %, at least about 60 wt %, at least about 65 wt %, at least about 70 wt %, at least about 75 wt %, at least about 80 wt %, or between about 80 wt % to about 90 wt %, relative to 100 wt % of the ethylene polymer blend composition.

Overall, the ethylene polymer blend composition may have a propylene content of at least about 5 wt %, at least about 10 wt %, between about 10 wt % to about 50 wt %, or between about 10 wt % to about 15 wt %, relative to 100 wt % of the ethylene polymer blend composition.

Overall, the ethylene polymer blend composition may have an increased melt flow rate, as compared to a same ethylene polymer without being blended with the other components in the ethylene polymer blend composition. In some embodiments, the ethylene polymer blend composition has a melt flow rate of at least about 1.0 g/10 min, at least about 1.5 g/10 min, at least about 2.0 g/10 min, at least about 2.5 g/10 min, at least about 3 g/10 min, at least about 3.5 g/10 min, at least about 4.0 g/10 min, or at least about 4.5 g/10 min, measured with a 2.16 kg melt indexer weight (at 190° C. or 230° C.), in accordance with ASTM D 1238. In some embodiments, the ethylene polymer blend composition has a melt flow rate of no more than about 50 g/10 min, no more than about 40 g/10 min, no more than about 20 g/10 min, or no more than about 10 g/10 min, measured with a 2.16 kg melt indexer weight (at 190° C. or 230° C.), in accordance with ASTM D 1238. In some embodiments, the ethylene polymer blend composition has a melt flow rate ranging from about 1 g/10 min to about 50 g/10 min, from about 2 g/10 min to about 40 g/10 min, from about 3 g/10 min to about 20 g/10 min, or from about 4 g/10 min to about 10 g/10 min, measured with a 2.16 kg melt indexer weight (at 190° C. or 230° C.), in accordance with ASTM D 1238.

When the melt flow rate is too high, the ethylene polymer blend composition may have a viscosity that is too low, and does not have sufficient melt strength. When the melt flow rate is too low, the ethylene polymer blend composition may be difficult to process as an additive-manufacture feedstock because the pressure can become too high to push through the printer nozzle.

In some embodiments, the ethylene polymer blend composition comprises post-consumer recycled material or post-industrial recycled material that may be derived from recycled waste. For example, one or more or all the components in the ethylene polymer blend composition may be derived from post-consumer recycled materials or post-industrial recycled materials. In some embodiments, the ethylene polymer blend composition comprises at least about 50 wt %, at least about 60 wt %, at least about 70 wt %, at least about 80 wt %, at least about 90 wt %, or virtually about 100 wt % post-consumer recycled material or post-industrial recycled material, relative to 100 wt % of the ethylene polymer blend composition.

In some embodiments, the ethylene polymer blend composition comprises at least 50 wt %, at least about 60 wt %, at least about 70 wt %, at least about 80 wt %, or at least about 90 wt % recycled rubber, relative to 100 wt % of the ethylene polymer blend composition.

In some embodiments, the ethylene polymer blend composition comprises at least about 1 wt %, at least about 5 wt %, at least about 10 wt %, or at least about 15 wt % recycled fiber, relative to 100 wt % of the ethylene polymer blend composition.

In some embodiments, the ethylene polymer blend composition comprises at least about 1 wt %, at least about 5 wt %, or at least about 10 wt % of one of the components, relative to 100 wt % of the ethylene polymer blend composition, that is not derived from the recycled materials.

In some embodiments, the ethylene polymer blend composition comprises about 80 wt % recycled polyolefin scrap, about 10 wt % recycled carbon fiber, and about 10 wt % polyolefin elastomer that is not derived from the recycled materials, relative to 100 wt % of the ethylene polymer blend composition.

The additive-manufacture feedstock can further comprise one or more additives that can be blended or compounded with the ethylene polymer blend composition.

In some embodiments, the additive-manufacture feedstock comprises at least about 51 wt % (at least about 60 wt %, at least about 70 wt %, at least about 80 wt %, at least about 90 wt %, at least about 95 wt %, at least about 98%, at least about 99 wt %, or at least about 99.5 wt %) of the ethylene polymer blend composition, and no more than about 49 wt % (no more than about 40 wt %, no more than about 30 wt %, no more than about 20 wt %, no more than about 10 wt %, no more than about 5 wt %, no more than about 2%, no more than about 1 wt %, or no more than about 0.5 wt %) of the additive, relative to 100% of the additive manufacture feedstock.

Suitable additives include but not limited to an organic or inorganic filler or a reinforcement; an antioxidant (e.g., a hindered phenol antioxidant, sulfur-containing compound-based antioxidant, or phosphorus-containing organic compound-based antioxidants; a pigment (or a dye); an adhesion-promoting agent, a biocide (e.g., an antibacterial, fungicide, or mildewcide), a whitening agent, a nucleating agent (or an auxiliary agent that promotes crystallization), an anti-static agent, an anti-blocking agent, a processing aid, a flame-retardant (e.g., a brominated compound, phosphate, or red phosphorus), a plasticizer (e.g., phthalates and phosphate), a heat stabilizer (e.g., a phenol heat stabilizer or acrylate heat stabilizer), a UV absorber (e.g., a benzotriazole-based UV absorber, benzophenone-based UV absorber, or salicylate-based UV absorber), a light stabilizer (e.g., an organic nickel-based light stabilizer or hindered amine-based light stabilizer), a viscosity-modifier, an elastomer, a thermoplastic polyurethane, a sliding agent, a sizing agent or compatibilizer, a rubber, a thermoplastic hydrocarbon resin, and any combinations thereof.

Suitable organic or inorganic fillers include, but are not limited to, graphene, talc, marble dust, cement dust, rice husk, clay, carbon black, feldspar, silica, glass, fumed silica, silicate, calcium silicate, silicic acid powder, glass microspheres, mica, metal oxide particles and nanoparticles such as magnesium oxide, antimony oxide, zinc oxide, barium sulfate, wollastonite, alumina, aluminum silicate, a titanium oxide, calcium carbonate, a polyhedral oligomeric silsesquioxane, and any combinations thereof.

A sliding agent can be incorporated into the ethylene polymer blend composition to improve elongation, toughness, and printability, through techniques known in the art. Suitable sliding agents include but are not limited to mineral oils; glycerol esters such as glycerol monostearate or glycerin monostearate glycerol; polyethers such as polypropylene glycol or polyethylene glycol; fluoropolymers; silanes; fatty acid amides such as oleoamides or eurucamide; and mixtures thereof. The amount of the sliding agent present in the additive-manufacture feedstock can range from about 0.05 to 3 wt %, from about 0.1 to 3 wt %, or from about 0.5 to 1 wt %, relative to 100 wt % of the additive-manufacture feedstock.

Suitable sizing agents can comprise an acid-modified propylene polymer, wherein the polymer of acid-modified propylene polymer being a homopolypropylene or a copolymer of propylene with another α-olefin, and the acid modification can be effected with an ethylenically substituted polycarboxylic acid or an anhydride, amide, or lower alkyl ester thereof, which has its ethylenic unsaturation on a C atom in a position alpha to at least one carboxyl group or potential carboxyl group. Suitable sizing agents can also include a siloxane, a silane, or a combination thereof. Examples include aminopropyltrimethoxysilane (APTES), trichlorovinylsilane (TCVS), (3-Glycidyloxypropyl)trimethoxysilane (GPTMS), (3-Mercaptopropyl)trimethoxysilane (MPTMS), and vinyltrimethoxysilane (VTMS), and polyalkylsiloxanes, such as polydimethylsiloxane.

Suitable compatibilizers include an epoxy resin, styrene-based polymer, polycarbonate polyol, polybutadiene polyol, polysiloxane polyol, and any combinations thereof.

Suitable thermoplastic hydrocarbon resins include those amorphous thermoplastic polymers produced by polymerization of unsaturated hydrocarbons, typically having a low molecular weight ranging from about 400 to 5000 g/mol. Exemplary thermoplastic hydrocarbon resins are C5 aliphatic, C9 aromatic, and DCPD cycloaliphatic resins. Aliphatic hydrocarbon resins (C5 Resins) are made from C5 piperylene and its derivatives, such as cis/trans 1,3-pentadienes, 2-methyl-2-butene, cyclopentene, cyclopentadiene, and dicyclopentadiene. Aromatic hydrocarbon resins (C9 Resins) are made from C9 aromatic hydrocarbons such as indene, methyindenes, dicyclopentadiene, styrene, alpha-methylstyrene and various vinyl toluenes. These resins are sometimes hydrogenated to reduce discoloration and to improve their heat and UV stability. Thermoplastic hydrocarbon resins can also be used to increase the tack properties of the additive-manufacture feedstock.

### Additive-Manufacture Feedstock and its Preparation

Certain aspects of the invention relate to the additive-manufacture feedstock described above to be supplied for 3D printing, in various forms or shapes, such as filaments (or rods, strands, etc.), powder or pellets, or a distribution of powders or pellets (e.g., solid or liquid suspensions, such as in a slurry/paste/clay or solid mixture form).

The additive-manufacture feedstock described herein as a consumable product may be prepared as a consumable product in the form of an extruded article. When in the extruded article form, the ethylene polymer blend composition in the additive-manufacture feedstock can exhibit a minimized warpage. For instance, the additive-manufacture feedstock containing the ethylene polymer blend composition, when forming into a printed article, may have a warpage resistance rating of no more than about 10%, no more than about 5%, no more than about 2%, or no more than about 1%; or, alternatively, the additive-manufacture feedstock containing the ethylene polymer blend composition, when forming into a printed article, may have a warpage-resistance rating improved at least 10%, at least 15%, at least 20%, or at least 25%, as compared to a printed article made from the same ethylene polymer without the blended component in the additive-manufacture feedstock. The warpage resistance rating is measured according to the following equation:

$$warpage resistance rating \% = 100 \times \frac{{\sum }_{i = 1}^{N} {WS}_{i}}{N} \% .$$

The variables in this warpage resistance rating equation and the measurement conditions are the same as those described above in the aspect of the invention relating to the ethylene polymer blend composition in an additive-manufacture feedstock.

All above descriptions and all embodiments discussed in the above aspect relating to the ethylene polymer blend composition in an additive-manufacture feedstock, including various components, features, and properties of the ethylene polymer blend composition; various additives; and the amounts used thereof are applicable to these aspects of the invention relating to various forms of the additive manufacture feedstock.

Some embodiments of the invention relate to a filament formed from the additive-manufacture feedstock containing the ethylene polymer blend composition as described in the above aspects. For instance, the additive-manufacture feedstock material may be extruded in a filament having a constant diameter. In some embodiments, the diameter of the filament ranges from 1 to 5 mm. For instance, the diameter of the filament may be 1.75 mm or 2.85 mm. Filaments with other diameters can also be extruded and used. The variation from the nominal diameter may be ±0.2 mm, ±0.05 mm, or ±0.03 mm.

The resulting filament of the additive-manufacture feedstock may be wound on a spool that may be connected to a 3D printer for printing. The length of the filament is unlimited and depends on the need and practicality for the supply. Typically, the filament may have a length of about 0.1 to 50000 meters.

Some embodiments of the invention relate to a powder formed from the additive-manufacture feedstock containing the ethylene polymer blend composition as described in the above aspects.

The powder may be suitable for powder bed fusion based 3D printing. In this type of printing, the quality of the printed articles depends on the properties of the ethylene polymer blend composition as well as the properties of the powders. For instance, the density of the printed part depends on how well the powders flow and pack in the powder bed. Accordingly, desirable shape of the powders is a balance between a shape that spreads well (e.g., spheres) and a shape that packs well (e.g., cylinders). Typically, the individual powder particle is ellipsoidal in shape, having a sphericity of from about 0.5 to about 1. The particle size distribution of the powders, defined by d₅₀, ranges from about 25 μm to about 150 μm. Typically, the powders have a particle size distribution, defined by d₅₀, ranging from about 40 μm to about 100 μm, for instance, from about 40 μm to about 80 μm, or from about 40 μm to about 50 μm. This allows for a better flow of the powders, and also allows for a printing layer height of 100 μm to 200 μm and a finer part resolution, when printing with powder bed fusion.

Some embodiments of the invention relate to a distribution (e.g., suspension) of pellets (or powders), each pellet (or powder) formed from the additive-manufacture feedstock containing the ethylene polymer blend composition as described in the above aspects. For instance, the additive-manufacture feedstock material may be extruded into powders or pellets.

The distribution (e.g., suspension) of the additive-manufacture feedstock may exist as solid or liquid suspensions of powders or pellets, e.g., in a slurry/paste/clay form, or in a solid mixture form. The distribution (e.g., suspension) of pellets (or powders) can be supplied to a 3D printer for printing. The distribution (e.g., suspension) of pellets (or powders) may have a count of 5 to 60 pellets per gram of the distribution, for instance, a count of 5 to 20 pellets per gram of the distribution, or a count of 30 to 60 pellets per gram of the distribution.

When forming an extruded article from the additive-manufacture feedstock, the additive-manufacture feedstock may be extruded by means known in the art using an extruder or other vessel apparatus. The term “extruder” takes on its broadest meaning and, includes any machine suitable for the extrusion of the ethylene polymer blend composition. For instance, the term includes machines that can extrude the additive-manufacture feedstock in the form of powder or pellets, rods, strands, fibers or filaments, sheets, or other desired shapes and/or profiles. Generally, an extruder operates by feeding the feedstock material through the feed throat (an opening near the rear of the barrel) which comes into contact with one or more screws. The rotating screw(s) forces the feedstock material forward into one or more heated barrels (e.g., there may be one screw per barrel). In many processes, a heating profile can be set for the barrel in which three or more independent proportional-integral-derivative controller (PID)-controlled heater zones can gradually increase the temperature of the barrel from the rear (where the plastic enters) to the front.

The vessel can be, for instance, a single-screw or a twin-screw extruder, or a batch mixer. Further descriptions about extruders and processes for extrusion can be found in U.S. Pat. Nos. 4,814,135; 4,857,600; 5,076,988; and 5,153,382; all of which are incorporated herein by reference in their entirety.

When a melt extrusion is used, the temperature and conditions for extruding the additive-manufacture feedstock may be different according to the type of the ethylene polymer blend composition.

Another aspect of the invention relates to a method of making an additive-manufacture feedstock. The method comprises: blending an ethylene polymer having a melt flow index of from 0.1 to 150 g/10 min (190° C./2.16 kg), measured according to ASTM D 1238, with at least one component selected from the group consisting of: a polyolefin elastomer, an ethylene-vinyl ester polymer, a fiber, a nucleator or clarifier, a polypropylene polymer, and combinations thereof, to form the ethylene polymer blend composition having an ethylene content of at least 50 wt %. The additive-manufacture feedstock, when in the form of a printed article, exhibits an improved printability characterized by a warpage-resistance rating of no more than about 10%, or an improved warpage-resistance rating of at least 20% as compared to a printed article made from the same ethylene polymer without the blended component in the additive-manufacture feedstock. The warpage resistance rating of the printed article may be measured according to the equation as described from the above aspects of the invention.

All above descriptions and all embodiments discussed in the above aspect relating to the ethylene polymer blend composition in an additive-manufacture feedstock, including various components, features, and properties of the ethylene polymer blend composition; various additives; and the amounts used thereof; and the variables in the warpage resistance rating equation and the measurement conditions for the warpage resistance rating equation are applicable to this aspect of the invention relating to a method of making an additive manufacture feedstock.

In some embodiments, when the additive-manufacture feedstock is supplied as an extruded article, the method may further comprise heating the additive-manufacture feedstock to a molten state, and extruding the additive-manufacture feedstock to form an extruded article.

In some embodiments, when the additive-manufacture feedstock is supplied as powders, those polymer powder production methods known to one skilled in the art can be applicable herein. For instance, various milling methods may be used, e.g., a cryogenic milling that utilizes a cryogenic grinder. The grinding apparatus may be a jet or an impact mill with a series of sieves used to separate out the desired particle sizes and recycle large particles back through the grinder. Additional methods for forming powders can be found in U.S. Pat. No. 10,343,303, U.S. Patent Application Publication No. 2018/0022024, and Japanese patent 2006-257117, all of which are incorporated herein by reference.

### 3D Printing Using the Additive-Manufacture Feedstock

### Extrusion-Based 3D Printing

Another aspect of the invention relates to a method of three-dimensional printing or additive manufacturing. The method comprises: (1) supplying the additive-manufacture feedstock as described from the above aspects of the invention to a printing apparatus and forming a hot-melt of the additive-manufacture feedstock; (2) depositing the hot-melt of the additive-manufacture feedstock from the printing apparatus on a substrate to form a first deposited printing layer; (3) repeating steps (1) and (2) to deposit a second printing layer on the first printing layer; and (4) optionally depositing at least one further printing layer on said second printing layer.

Certain aspects of the invention also relate to an article formed from the ethylene polymer blend composition described above. The article may be formed by the extrusion-based three-dimensional printing or additive manufacturing, as described herein.

All above descriptions and all embodiments discussed in the above aspect relating to the ethylene polymer blend composition in an additive-manufacture feedstock, including various components, features, and properties of the ethylene polymer blend composition; various additives; and the amounts used thereof are applicable to this aspect of the invention relating to a method of three-dimensional printing or additive manufacturing and relating to an article formed from the ethylene polymer blend composition.

Additionally, all above descriptions and all embodiments discussed in the above aspect relating to the method of making an additive-manufacture feedstock are also applicable to these aspects of the invention relating to a method of three-dimensional printing or additive manufacturing and relating to an article formed from the ethylene polymer blend composition.

The printing apparatus (i.e., the 3D printer) can employ various 3D printing technologies known in the art. In some embodiments, the printing apparatus employs an extrusion-based 3D printing technology. For instance, an extrusion-based 3D printer may be used to build a 3D model from a digital representation of the 3D model in a layer-by-layer manner by extruding a flowable modeling additive-manufacture feedstock.

In one embodiment, the printing apparatus employs a fused filament fabrication (FFF) (or fused deposition modelling, FDM) method. In an exemplary embodiment, a filament of the additive-manufacture feedstock is extruded through an extrusion tip carried by an extrusion head and deposited as a sequence of roads on a substrate in an x-y plane. The extruded additive-manufacture feedstock fuses to previously deposited additive-manufacture feedstock and solidifies upon decreasing temperature. The position of the extrusion head relative to the substrate is then incremented along a z-axis (perpendicular to the x-y plane), and the process is then repeated to form a 3D model resembling the digital representation. Movement of the extrusion head with respect to the substrate is performed under computer control, in accordance with build data that represents the 3D model. The build data is obtained by slicing the digital representation of the 3D model into multiple horizontally sliced layers. For each sliced layer, the host computer generates a build path for depositing roads of modeling material to form the 3D model.

In one embodiment, the printing apparatus employs a fused particle fabrication (FPF) (or fused granular fabrication, FGF) method.

In one embodiment, the printing apparatus employs a fused filament fabrication (FFF) (or fused deposition modelling, FDM) method.

In one embodiment, the printing apparatus employs a pellet extrusion method.

The additive-manufacture feedstock may be supplied to the printing apparatus in various forms or shapes, such as filaments (or rods, strands, etc.), powder or pellets, or a distribution (e.g., solid or liquid suspensions, such as in a slurry/paste/clay or solid mixture form) of powders or pellets, as discussed above.

The supplied additive-manufacture feedstock is then printed, according to the modeling based on the 3D method (e.g., FFF or FPF model), by first forming a hot-melt of the additive-manufacture feedstock (at a temperature above the melting point and/or softening point of one or more components of the additive-manufacture feedstock), and then depositing the hot-melt of the additive-manufacture feedstock from the printing apparatus on a substrate to form a first deposited printing layer. The hot-melt of the additive-manufacture feedstock may be formed by extruding the additive-manufacture feedstock through the printing apparatus.

The supplying and depositing steps are repeated to deposit a second printing layer and further printing layer(s) on the first printing layer, until a printed article according to the 3D model is obtained.

The deposited printing layer(s) or final printed article may be solidified by a method known in the art. For instance, the deposited printing layer or final printed article may be further treated by vapor-based post-processing methods as defined in, e.g., WO 2015/124639A1, U.S. Pat. No. 8,123,999, WO 2016/030490A1, WO 2020/148457A1, and US Patent Publication No. 2019/0375148, all of which are incorporated by reference in their entirety, as well as sintering, hydrating, coating, melting, infiltrating, freezing, crystallizing, precipitating and/or crosslinking.

### Powder Bed Fusion Based 3D Printing

Another aspect of the invention relates to a method of three-dimensional printing or additive manufacturing. The method comprises: (1) depositing a layer of the additive-manufacture feedstock containing the ethylene polymer blend composition as described from the above aspects of the invention to a printing apparatus; (2) irradiating the additive-manufacture feedstock at a temperature range that sinters the additive-manufacture feedstock and causes at least a portion of the additive-manufacture feedstock to fuse and form a first printing layer; (3) repeating steps (1) and (2) to form a second printing layer on the first printing layer; and (4) optionally forming at least one further printing layer on said second printing layer.

Another aspect of the invention relates to a method of three-dimensional printing or additive manufacturing. The method comprises coalescing the additive-manufacture feedstock containing the ethylene polymer blend composition as described from the above aspects of the invention. The coalescing can occur by heating particles of the ethylene polymer blend composition, or by impacting particles of the ethylene polymer blend composition against a build plate in a technique known as cold spray additive manufacturing.

Certain aspects of the invention also relate to an article formed from the ethylene polymer blend composition described above. The article may be formed by powder bed fusion based three-dimensional printing or additive manufacturing, as described herein.

All above descriptions and all embodiments discussed in the above aspect relating to the ethylene polymer blend composition in an additive-manufacture feedstock, including various components, features, and properties of the ethylene polymer blend composition; various additives; and the amounts used thereof are applicable to this aspect of the invention relating to a method of three-dimensional printing or additive manufacturing and relating to an article formed from the ethylene polymer blend composition.

Additionally, all above descriptions and all embodiments discussed in the above aspects relating to the method of making an additive-manufacture feedstock are also applicable to these aspects of the invention relating to a method of three-dimensional printing or additive manufacturing and relating to an article formed from the ethylene polymer blend composition.

The method described in these aspects of the invention employs powder bed fusion based 3D printing technology. In powder bed fusion based 3D printing technology, the additive-manufacture feedstock (e.g., powders or pellets containing the ethylene polymer blend composition) is sintered and fused together using an external energy source or binder. Sections of the additive-manufacture feedstock can be selectively fused together using an energy source, a low-viscosity adhesive, or a combination of a low-viscosity ink and an energy source that preferentially targets areas containing the ink. These technologies may be sensitive to the flow properties of the sintering medium, the amount of energy absorbed, the kinetics of crystallization relative to chain diffusion, and the size and shape of the initial additive-manufacture feedstock material.

In a typical powder bed fusion based printing process, the 3D printer fills its chamber with an inert gas and then heats it to the printing temperature, which may be a range between the crystallization temperature and melting temperature of the ethylene polymer blend composition. A thin layer of additive-manufacture feedstock (e.g., powders of the ethylene polymer blend composition) is then applied to the build platform of the printing apparatus, according to a pre-determined layer thickness. An energy source (e.g., a fiber optic laser, at 200/400 W; a CO₂ laser, at 20-200 W; a LED array; or any energy source that emits in the near, mid, or far-infrared spectrum) is applied to the cross-section of the additive-manufacture feedstock to irradiate the ethylene polymer blend composition, causing at least a portion of the ethylene polymer blend composition to fuse together and form a first printing layer. When the layer is finished, the platform moves down, allowing another layer of additive-manufacture feedstock to be added. The process is repeated until the final article is obtained.

The printing temperature is typically above the crystallization temperature of the ethylene polymer blend composition to minimize warping of the printed article. The printing temperature may be as close to the melting temperature of the ethylene polymer blend composition as is possible without actually melting the additive-manufacture feedstock material. This is done to minimize the difference in temperature between the sintered material and the powder bed (as a high differential can cause the printed part to curl) as well as to minimize the amount of energy required for printing.

The printing apparatus (i.e., the 3D printer) can employ various 3D printing technologies known in the art broadly as powder bed fusion (PBF). In some embodiments, the printing apparatus employs an agent and energy for fusion, e.g., a multi jet fusion (MJF) method or high speed sintering (HSS) method. In some embodiments, the printing apparatus employs an energy source that is based on thermal fusion, e.g., selective heat sintering (SHS). In some embodiments, the printing apparatus employs an energy source that is based on laser fusion, such as selective laser sintering (SLS), selective laser melting (SLM) method, or direct metal laser sintering (DMLS) method. In some embodiments, the printing apparatus employs an agent for fusion, e.g., a binder jetting (BJ) method. In some embodiments, the printing apparatus employs an energy source that is based on electron beam fusion, such as electron beam melting (EBM) method. Some of these technologies, such as SLM, DMLS, BJ, and EBM, are typically used for metal and/or ceramic parts. However, when appropriate binders/additives are used in the ethylene polymer blend composition, these technologies can be suitable to print the ethylene polymer blend composition described herein.

In one embodiment, the printing apparatus employs selective laser sintering.

In another embodiment, the printing apparatus (i.e., the 3D printer) can be one useful in the cold spray additive manufacturing technique, wherein the polymer particles can be accelerated at a substrate, and the particles can be fused together by the energy imparted on them at impact with the substrate. In one embodiment, the additive-manufacture feedstock material can have a d₅₀ of from about 1 to about 10 microns.

The additive-manufacture feedstock may be supplied to the printing apparatus in various forms or shapes, such as powder or pellets, or a distribution (e.g., suspensions, such as in a slurry/paste/clay or solid mixture form) of powders or pellets, as discussed above.

### EXAMPLES

The following examples are for illustrative purposes only and are not intended to limit, in any way, the scope of the present invention.

### Example 1—Additive-Manufacture Feedstock Having an Ethylene Polymer Blend Composition and Additive Manufacturing by Extrusion

### Ethylene Polymer Blend Compositions

A commercially available Braskem high density polyethylene (HDPE), having a melt flow rate of 2.1-2.3 g/10 min measured according to ASTM D 1238 (190° C./2.16 kg), and a density of about 0.95 g/cm³ measured according to ASTM D 792, in the form of pellets was used for a component in the ethylene polymer blend composition. A commercially available recycled carbon fiber (CF) (Vartega, Golden, Colo.) in the form of fiber bundles was used for a component in the ethylene polymer blend composition. A commercially available Braskem polypropylene homopolymer (HPP) having a melt flow rate of 12 g/10 min, measured according to ASTM D 1238 (230° C./2.16 kg) in the form of pellets was used for a component in the ethylene polymer blend composition. A commercially available thermoplastic elastomer (TPE), which is an ethylene-octene (EO) polyolefin elastomer (POE), having a melt flow rate of 5 g/10 min, measured according to ASTM D 1238 (190° C./2.16 kg) (Engage 8200, Dow) in the form of pellets was used for a component in the ethylene polymer blend composition.

The above components were blended and compounded into various exemplary ethylene polymer blend compositions (Samples 1-4) according to the formulations listed in Table 1. The comparative example (Sample C1) was the commercially available Braskem HDPE having a melt flow rate of 2.1-2.3 g/10 min, measured according to ASTM D 1238 (190° C./2.16 kg), discussed above, without being blending with any other components.

TABLE 1
Formulations of the exemplary ethylene polymer blend compositions, as
compared to a commercial ethylene polymer (HDPE), and their properties.

| | | | | | | | Melt Flow Rate | |
|---|---|---|---|---|---|---|---|---|
| | | | | | ¹³C NMR | | (g/10 min) | |
| | Components (wt %) | | | | C2 Content | C3 Content | 230° C., | 190° C., |
| Sample | HDPE | HPP | TPE | CF | (wt %)* | (wt %)* | 2.16 kg | 2.16 kg |
| Sample C1 | 100 | 0 | 0 | 0 | 98.8 | 0 | 4.1 | 2.3 |
| Sample 1 | 78.0 | 22.0 | 0 | 0 | 85.5 | 13.4 | 5.3 | 2.9 |
| Sample 2 | 70.2 | 19.8 | 10.0 | 0 | 83.4 | 12.5 | 5.3 | 3.1 |
| Sample 3 | 62.4 | 17.6 | 20.0 | 0 | 82.2 | 10.5 | 5.9 | 3.2 |
| Sample 4 | 62.4 | 17.6 | 10.0 | 10 | 80.4 | 14.7 | 4.6 | 2.5 |

*C2 content means the amounts of polymer units derived from ethylene comonomer; C3 content means the amounts of polymer units derived from propylene comonomer; the C2 and C3 contents were determined by ¹³C NMR spectroscopy.

### Measuring Structural Properties of the Polymer Samples

Melt flow rate (MFR) measurements. The melt flow rates of the polymer samples were measured at 230° C. with a 2.16 kg melt indexer weight in accordance with the ASTM D 1238 standard. The melt flow rates of the polymer samples were also measured at 190° C. with a 2.16 kg melt indexer weight in accordance with the ASTM D 1238 standard.

¹³C nuclear magnetic resonance (NMR). ¹³C NMR of the polymer samples was recorded on a Bruker Avance III HD 500 MHz spectrometers with a 10 mm cryoprobe. The solvent was a mixture of 1,1,2,2-tetrachloroethylane-D2 and o-dichlorobenzene (1:4) and samples were tested at 120° C. The ethylene content (C2 wt %) and propylene content (C3 wt %) were determined using ¹³C NMR spectroscopy in accordance with the procedures described in Kakugo et al., Macromolecules 15, 1150-1152, 1982, which is incorporated herein by reference in its entirety.

### Filament Production and 3D Printing

All the above polymer samples were melt-blended and compounded in a 3DEVO filament maker, a single screw extruder, to form a filament having a constant diameter of 1.75 mm (±0.2) or 2.85 mm (±0.2). The filament obtained was wound on a spool that may be connected to the 3D printer.

The filament was then loaded to a Fused Filament Fabrication based desktop 3D printer Ultimaker S5 (Ultimaker), and printed with the following print parameters to form a printed article:

Nozzle diameter—0.6 mm (for material with CF); 0.4 mm (for material without CF)

Printing temperature—230° C.

Bed Temperature Initial—110° C.

Bed temperature—60° C.

Thickness of layer—0.2 mm

Print speed—45 mm/s

Print speed (initial layer)—15 mm/s

Brim—10 mm (inside and outside)

Wall count—3

### Example 2—Method for Measuring the Warpage Resistance Rating

To evaluate the warpage resistance rating of an additive-manufacture feedstock in the form of a printed article (whether an inventive additive-manufacture feedstock or a comparative additive-manufacture feedstock), a number of specimens are printed and measured. In this example, three specimens are printed and measured for the warpage resistance rating evaluation.

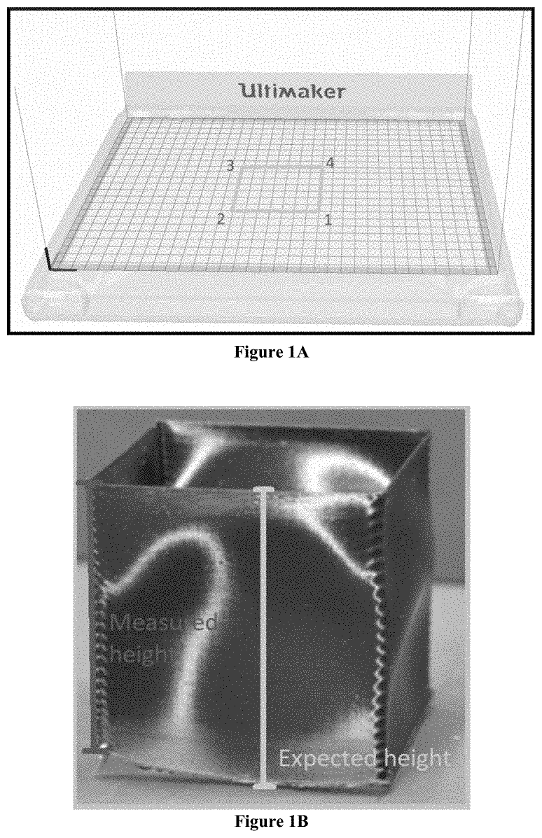

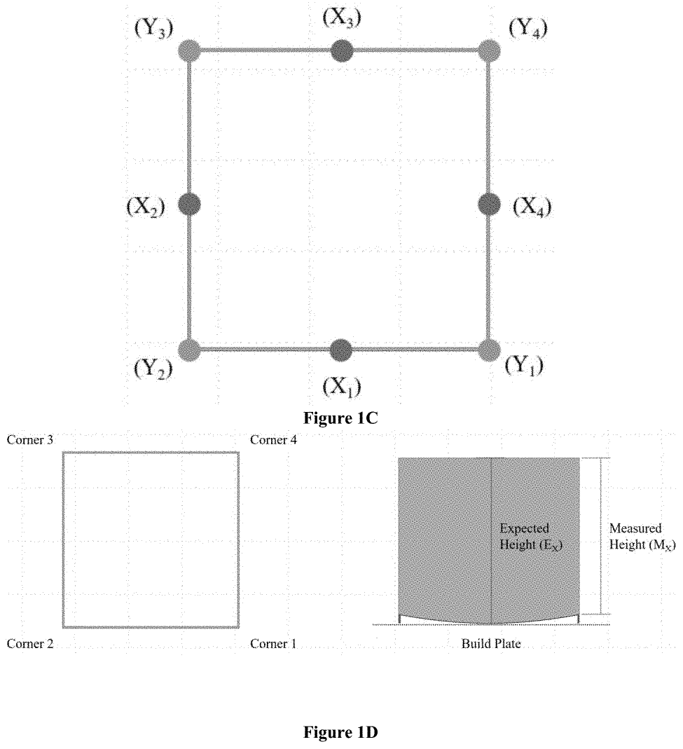

Three 60 mm×60 mm×h mm, open-ended boxes are printed with the additive-manufacture feedstock to be evaluated. For each printing, the print orientation is X-Y, as shown in FIG. 1A. The full model height of the box is 60 mm, but the actual height of the printed boxes h may vary between 30 mm to 60 mm. The thickness of each wall is 1 mm.

The printing program used to print each specimen develops a model of the specimen to be printed, and the expected height for any edge of the object is defined the model. FIG. 1B shows one printed open-ended, thin-walled box, which overlays the expected height of one edge from the model. FIG. 1B also shows the measured height of the printed open-ended, thin-walled box for the same edge.

For the purpose of evaluating the warpage resistance rating, FIG. 1C illustrates an exemplary box projecting onto the X-Y plane and identifying the locations for X₁, X₂, X₃, and X₄, and Y₁, Y₂, Y₃, and Y₄. Each location of X₁, X₂, X₃, and X₄ represents a central edge of a box, wherein the central edge is found at the center point of a sidewall of the box, e.g., at 30 mm, ±0.5 mm, from a corner edge. Each location of Y₁, Y₂, Y₃, and Y₄ represents a corner edge of a box.

To evaluate the warpage resistance rating of a particular feedstock, each of the three printed boxes are reviewed, and the height of the printed object on each locations of X₁, X₂, X₃, and X₄ and Y₁, Y₂, Y₃, and Y₄ are measured and recorded. For each of the three boxes, the heights of the central edges from all sidewalls, i.e., the heights at the locations of X₁, X₂, X₃, and X₄, are compared and the greatest height (or the greatest value from X₁, X₂, X₃, and X₄) is identified and recorded. For each of the three boxes, the heights of the corner edges from all sidewalls, i.e., the heights at the locations of Y₁, Y₂, Y₃, and Y₄, are compared and the shortest or least height (or the smallest value from Y₁, Y₂, Y₃, and Y₄) is identified and recorded. Thereafter, the warpage value, WS, for each box is determined. The warpage values for boxes 1, 2, and 3, are WS₁, WS₂, and WS₃, respectively.

The warpage resistance rating is thus given by the following equation:

$$warpage resistance rating \% = 100 \times \frac{{\sum }_{i = 1}^{N} {WS}_{i}}{N} \%$$

In the equation, N is the total number of printed articles measured for warpage resistance rating evaluation. In this case, N is 3.

WS₁=[Max (X₁,X₂,X₃,X₄)₁−Min (Y₁,Y₂,Y₃,Y₄)₁]/Max (X₁,X₂,X₃,X₄)₁ for a first printed box.

WS₂=[Max (X₁,X₂,X₃,X₄)₂−Min (Y₁,Y₂,Y₃,Y₄)₂]/Max (X₁,X₂,X₃,X₄)₂ for a second printed box.

WS₃=[Max (X₁,X₂,X₃,X₄)₃−Min (Y₁,Y₂,Y₃,Y₄)₃]/Max (X₁,X₂,X₃,X₄)₃ for a third printed box.

As noted above, X₁, X₂, X₃, and X₄, respectively, represent a height of a first central edge, a height of a second central edge, a height of a third central edge, and a height of a fourth central edge, for each of the first, second, and third printed box. Y₁, Y₂, Y₃, and Y₄, respectively, represent a height of a first corner edge, a height of a second corner edge, a height of a third corner edge, and a height of a fourth corner edge, for each of the first, second, and third printed box.

Accordingly, Max (X₁,X₂,X₃,X₄)₁ represents the maximum value of X₁, X₂, X₃, and X₄, for the first printed box. Max (X₁,X₂,X₃,X₄)₂ represents the maximum value of X₁, X₂, X₃, and X₄, for the second printed box. Max (X₁,X₂,X₃,X₄)₃ represents the maximum value of X₁, X₂, X₃, and X₄, for the third printed box. Min (Y₁,Y₂,Y₃,Y₄)₁ represents the minimum value of Y₁, Y₂, Y₃, and Y₄, for the first printed box. Min (Y₁,Y₂,Y₃,Y₄)₁ represents the minimum value of Y₁, Y₂, Y₃, and Y₄, for the second printed box. Min (Y₁,Y₂,Y₃,Y₄)₁ represents the minimum value of Y₁, Y₂, Y₃, and Y₄, for the third printed box.

FIG. 1D provides another view and illustration for a hypothetical box for which the warpage resistance is determined according to the above equation. As shown in the right view of FIG. 1D, the heights of the central and corner edges are measured from the bottom edge of the box that touches the build plate, not from the build plate itself. Because the thermodynamic warpage typically occurs the least in the center edge of the box, the height measured at the center edge for each sidewall of the printed box mostly corresponds to the expected height defined by the model; whereas the height measured at the corner edge for each sidewall of the printed box often records the highest possible warp, because the thermodynamic warpage is typically its highest at sharp corners where stresses are concentrated. Accordingly, in the equation above, Max (X₁,X₂,X₃,X₄) would record a value approximate the expected height defined by the model (Eₓ), and Min (Y₁,Y₂,Y₃,Y₄) would record the lowest measured height (Mₓ).

The warpage calculated for each printed box would therefore be determined from a measured height that has the greatest difference from the expected height. Because the possible variance in the actual height of the printed boxes, the warpage resistance rating, WSᵢ, is evaluated based on the calculated warpage divided by Max (X₁,X₂,X₃,X₄), the value approximate the expected height. The warpage resistance rating for each printed article, WSᵢ, is thus a % rating. The average value of the WSᵢ values determined for all i (in this case, 3) boxes would be the warpage resistance rating of that particular feedstock used to print the boxes.

### Example 3—Measurements of the Warpage Resistance Rating

To illustrate the minimized warpage and improved printability exhibited by the additive-manufacture feedstock according to this invention, the warpage resistance rating of the inventive additive-manufacture feedstock in the form of a printed article was determined, and compared against the warpage resistance rating of the comparative additive-manufacture feedstock in the form of a printed article was determined.

The inventive additive-manufacture feedstock samples (Samples 1-4) were prepared according to Example 1. See also, Table 1. The comparative additive-manufacture feedstock sample (Sample C1) was also described in Example 1. See also, Table 1.

The filaments from each of the inventive additive-manufacture feedstock and the comparative additive-manufacture feedstock were then loaded and printed using the instrument and parameters described in Example 1. Magigoo PP-GF (Magigoo) was used as bed adhesion solution.

The warpage resistance rating (%) for each additive-manufacture feedstock (inventive Samples 1-4 and comparative Sample C1) was determined according to the method described in Example 2. To evaluate the warpage resistance rating of each of the additive-manufacture feedstock in the form of a printed article, three 60 mm×60 mm×h mm (h is between 30-60 mm), open-ended boxes were printed for each of the additive-manufacture feedstock to be evaluated. For each printing, the print orientation is X-Y, and the thickness of each wall is 1 mm. The results are listed in Table 2.

TABLE 2
The warpage resistance ratings and printability improvement
determined for various polymer samples.

| Sample No. | Warpage Resistance Rating | Printability Improvement* |
|---|---|---|
| Sample C1 | 3.44% | 0% |
| Sample 1 | 2.67% | 22.4% |
| Sample 2 | 2.15% | 37.6% |
| Sample 3 | 1.87% | 45.7% |
| Sample 4 | 0.67% | 80.7% |

*The printability improvement was determined by comparing the warpage resistance rating of each inventive sample against that of comparative sample, Sample C1.

As shown above in Table 2, the comparative additive-manufacture feedstock (Sample C1), a commercial grade HDPE polymer composition without being blended with other components such as HPP, TPE, and/or CF, when forming a printed article, had a greatest warpage resistance rating, 3.44%. On the other hand, the inventive additive-manufacture feedstock (Samples 1-4), an ethylene polymer blend containing HPP, TPE, and/or CF, when forming a printed article, all had an improved warpage resistance rating as compared to the comparative additive-manufacture feedstock, with the improved warpage resistance rating varying from 22.4% to 80.7%. Therefore, the inventive additive-manufacture feedstock material had a significant improvement in resisting the thermodynamic warping during 3D printing.

What is claimed is:

1. An additive-manufacture feedstock, comprising
an ethylene polymer blend composition having:
an ethylene polymer having a melt flow index of from 0.1 to 150 g/10 min (190° C./2.16 kg), measured according to ASTM D 1238, and
at least one component blended in the ethylene polymer selected from the group consisting of:
a polyolefin elastomer,
an ethylene-vinyl ester polymer,
a fiber,
a nucleator or clarifier,
a polypropylene polymer, and
combinations thereof;
wherein:
the ethylene polymer blend composition has an ethylene content of at least 50 wt %, and
the additive-manufacture feedstock, when in the form of a printed article, exhibits an improved printability characterized by an improved warpage-resistance rating of at least 20%, as compared to a printed article made from the same ethylene polymer without the blended component in the additive-manufacture feedstock.

2. The additive manufacture feedstock of claim 1, wherein the warpage resistance rating is measured according to the following equation:
$$warpage resistance rating \% = 100 \times \frac{{\sum }_{i = 1}^{N} {WS}_{i}}{N} \%$$
wherein:
Σᵢ₌₁^{N} WSᵢ sums the values of WSi, starting at WS₁ and ending with WS_{N},
N is the total number of printed articles measured for warpage resistance rating evaluation,
i is a i^{th} printed article measured,
WSi=[Max (X₁,X₂,X₃,X₄)₁−Min (Y₁,Y₂,Y₃,Y₄)ᵢ]/Max (X₁,X₂,X₃,X₄)ᵢ for a i^{th} printed article measured,
X₁, X₂, X₃, and X₄, respectively, represent a height of a first central edge, a height of a second central edge, a height of a third central edge, and a height of a fourth central edge, of the i^{th} printed article measured,
Y₁, Y₂, Y₃, and Y₄, respectively, represent a height of a first corner edge, a height of a second corner edge, a height of a third corner edge, and a height of a fourth corner edge, of the i^{th} printed article measured,
Max (X₁,X₂,X₃,X₄)ᵢ represents the maximum value of X₁, X₂, X₃, and X₄, for the i^{th} printed article measured, and
Min (Y₁,Y₂,Y₃,Y₄)ᵢ represents the minimum value of Y₁, Y₂, Y₃, and Y₄, for the i^{th} printed article measured,
wherein each printed article measured for warpage resistance rating evaluation is a 60 mm×60 mm×h mm box, each side of the box having a thickness of 1 mm, wherein h is from 30 mm to 60 mm.

3. The additive-manufacture feedstock according to claim 1, wherein the ethylene polymer blend composition has an ethylene content of at least 55 wt %.

4. The additive-manufacture feedstock according to claim 1, wherein the ethylene polymer blend composition has a propylene content of at least 10 wt %.

5. The additive-manufacture feedstock according to claim 4, wherein the ethylene polymer blend composition has a melt flow index of at least 3 g/10 min (230° C./2.16 kg), measured according to ASTM D 1238.

6. The additive-manufacture feedstock according to claim 1, wherein the ethylene polymer is an ethylene copolymer comprising at least one olefinic comonomer selected from the group consisting of propylene, 1-butene, 1-pentene, isobutene, 1-hexene, and 1-octene.

7. The additive-manufacture feedstock according to claim 6, wherein the ethylene polymer is high-density polyethylene (HDPE).

8. The additive-manufacture feedstock according to claim 1, wherein the polypropylene polymer is present from 0.1 to 65 wt %, relative to 100 wt % of the ethylene polymer blend composition.

9. The additive-manufacture feedstock according to claim 8, wherein the polypropylene polymer has a melt flow rate of from 0.1 to 150 g/10 min (230° C./2.16 kg), measured according to ASTM D1238.

10. The additive-manufacture feedstock according to claim 8, wherein the polypropylene polymer comprises at least one member selected from the group consisting of a polypropylene homopolymer, a polypropylene block copolymer, a random copolymer of propylene and ethylene, and a heterophasic copolymer.

11. The additive-manufacture feedstock according to claim 1,
wherein the polyolefin elastomer is present in an amount of from 0.1-60 wt %, relative to 100 wt % of the ethylene polymer blend composition; and
wherein the polyolefin elastomer is a copolymer of at least two olefinic comonomers selected from the group consisting of ethylene, propylene, butene, hexene, and octene.

12. The additive-manufacture feedstock according to claim 1,
wherein the ethylene-vinyl ester polymer is present in an amount of from 0.1 to 60 wt %, relative to 100 wt % of the ethylene polymer blend composition; and
wherein the ethylene-vinyl ester polymer has:
a melt flow rate of from 0.1 to 150 g/10 min (190° C./2.16 kg), measured according to ASTM D 1238, and
a vinyl ester content of from 1.0 to 30 wt %, relative to 100 wt % of the ethylene-vinyl ester polymer.

13. The additive-manufacture feedstock according to claim 1,
wherein the fiber is present in an amount of from 0.1 to 20 wt %, relative to 100 wt % of the ethylene polymer blend composition; and
wherein the fiber comprises at least one member selected from the group consisting of natural fiber, metal fiber, ceramic fiber, glass fiber, and carbon fiber.

14. The additive-manufacture feedstock according to claim 1, wherein the nucleator or clarifier is present in an amount of from 0.0001 to 10 wt %, relative to 100 wt % of the ethylene polymer blend composition.

15. The additive-manufacture feedstock according to claim 1, wherein the ethylene polymer blend composition comprises at least 50 wt % post-consumer or post-industrial recycled material, relative to 100 wt % of the ethylene polymer blend composition.

16. The additive-manufacture feedstock according to claim 1, further comprising an additive selected from the group consisting of an antioxidant, a pigment, an organic or inorganic filler, an adhesion-promoting agent, a biocide, a whitening agent, an anti-static agent, an anti-blocking agent, a processing aid, a flame-retardant, a plasticizer, a heat stabilizer, a light stabilizer, a viscosity-modifier, an elastomer, a thermoplastic polyurethane, a sizing agent or compatibilizer, a rubber, a thermoplastic hydrocarbon resin, and any combination thereof.

17. The additive-manufacture feedstock according to claim 16, wherein the additive is an organic or inorganic filler comprising at least one member selected from the group consisting of graphene, talc, marble dust, cement dust, rice husk, clay, carbon black, feldspar, silica, glass, fumed silica, silicate, calcium silicate, silicic acid powder, glass microspheres, mica, magnesium oxide, antimony oxide, zinc oxide, barium sulfate, wollastonite, alumina, aluminum silicate, titanium oxide, calcium carbonate, and polyhedral oligomeric silsesquioxane.

18. The additive-manufacture feedstock according to claim 16, comprising:
at least 51% of the ethylene polymer blend composition, and
not more than 49% of the additive, relative to 100 wt % of the additive manufacture feedstock.

19. The additive-manufacture feedstock according to claim 1,
wherein the ethylene polymer blend composition comprises a polymeric fraction that consists of the ethylene polymer and at least one components selected from the group consisting of the polyolefin elastomer, the ethylene-vinyl ester polymer, and the polypropylene polymer; and
wherein the polymeric fraction has an ethylene content of at least 50 wt %.

20. A filament, comprising the additive-manufacture feedstock according to claim 1.

21. A powder, comprising the additive-manufacture feedstock according to claim 1.

22. A distribution of pellets, each pellet comprising the additive-manufacture feedstock according to claim 1.

23. A method of three-dimensional printing, the method comprising:
(1) supplying the additive-manufacture feedstock according to claim 1 to a printing apparatus and forming a hot-melt of the additive-manufacture feedstock;
(2) depositing the hot-melt of the additive-manufacture feedstock from the printing apparatus on a substrate to form a first deposited printing layer;
(3) repeating steps (1) and (2) to deposit a second layer on the first printing layer; and
(4) optionally depositing at least one further printing layer on the second printing layer.

24. A method of additive manufacturing, the method comprising:
(1) depositing a layer of the additive-manufacture feedstock of claim 1 to a printing apparatus;
(2) irradiating the additive-manufacture feedstock at a temperature range that sinters the additive-manufacture feedstock and causes at least a portion of the additive-manufacture feedstock to fuse and form a first printing layer;
(3) repeating steps (1) and (2) to form a second printing layer on the first printing layer; and
(4) optionally forming at least one or more further printing layer(s) on said second printing layer.

25. A method of additive manufacturing, the method comprising:
coalescing the additive-manufacture feedstock of claim 1.
